(19) United States
(12) Patent Application Publication
(10) Pub. No.: US 2024/0210297 A1
(43) Pub. Date: Jun. 27, 2024

(54) OBLIQUE ILLUMINATION OF SAMPLES IMAGED USING FLOW THROUGH MICROSCOPY

(71) Applicant: Beckman Coulter, Inc., Brea, CA (US)

(72) Inventor: Jozef SOFKA, Miami, FL (US)

(21) Appl. No.: 18/564,650

(22) PCT Filed: May 16, 2022
(86) PCT No.: PCT/US2022/029378

§ 371 Date: Nov. 28, 2023

Related U.S. Application Data
(60) Provisional application No. 63/192,297, filed on May 24, 2021.

(51) Int. Cl. G01N 15/0227; G01N 15/01; G01N 15/14; G01N 15/1434

(52) U.S. Cl. CPC G01N 15/0227; G01N 15/01; G01N 15/1434; G01N 15/147; G01N 2015/1445

(57) ABSTRACT

Techniques for oblique illumination of samples in microscopy imaging are presented. The sample may be obliquely illuminated by directing light from a light emitter toward a sample at an oblique angle, rather than directly along the optical axis of an imaging device. The oblique angle may be created using an aperture mask with an aperture that is not coaxial with the optical axis of the imaging device. The oblique angle may also be created using a light emitter and collector lens that are not coaxial with the optical axis of the imaging device, such that the condenser lens directs the light toward the sample. Images obtained using the oblique illumination provide improved contrast of translucent particles and may have an embossed, three-dimensional appearance.

### BACKGROUND

Imaging of cells and particles in a sample fluid stream can be used to identify the cells and particles and determine whether an individual is healthy or is suffering from illness or disease. To gather the necessary information from the images, the image must be clear and clearly show the particles and cells within the sample fluid stream. Currently available imaging on sample fluid system often provide little contrast for, for example, translucent particles and cells in the sample fluid stream, making some particles and cells difficult to detect in the images.

### BRIEF SUMMARY

One general aspect may include a system for microscopy, the system may include a flowcell containing a sample. The system may also include an oblique illumination system configured to obliquely illuminate the sample in the flowcell. The system may also include an imaging device configured to capture the images of the sample during the illumination of the sample. The oblique illumination system may include a light emitter configured to provide illumination of the sample by emitting light, where the illumination is used to capture images of the sample. The oblique illumination system may also include a collector lens for collecting the light from the light emitter, where the collector lens is located between the light emitter and the flowcell. The oblique illumination system may also include a condenser lens for receiving and directing the light from the collector lens toward the sample in the flowcell, where the condenser lens is located between the flowcell and the collector lens. Obliquely illuminating the sample may refer to illuminating the sample at an oblique angle. An oblique angle means a non-zero angle that is not 90°. The oblique angle may be relative to the optical axis of the imaging device, the normal to the sample or the plane of the sample. The oblique angle may be within the range of, for example, 5-85°, 10-80° or 20-70°. Other embodiments of this general aspect include corresponding computer systems, apparatus, and computer programs recorded on one or more computer storage devices, each configured to perform the actions of microscopy methods corresponding to the described system.

Implementations may include one or more of the following features. In some embodiments, the sample is a urine sample, a blood sample, a cerebrospinal fluid sample, a synovial fluid sample, a serous fluid sample, a pleural fluid sample, a pericardial fluid sample, a peritoneal fluid sample, or an amniotic fluid sample. In some embodiments, the light emitter is a light emitting diode. In some embodiments, the light emitter is an arc lamp. In some embodiments the sample in the flowcell is moving and the illumination from the light emitter is light pulses. The use of light pulses to illuminate the moving sample advantageously prevent blurring in the captured images. In some embodiments the sample in the flowcell is not moving and the illumination from the light emitter is continuous. Implementations of the described techniques may include hardware, a method or process, or computer software on a computer-accessible medium.

In some embodiments, the oblique illumination system may also include an aperture mask including an aperture, where the aperture mask allows the light from the collector lens to pass through the aperture, and where the aperture is not centered on the aperture mask such that the illumination of the sample is non-symmetrical. The aperture mask may preferably be an opaque mask that blocks light from the collector lens everywhere except through the aperture. Optionally, the light emitter, the collector lens, the aperture mask, the condenser lens, and the sample are each centered on an optical axis of the imaging device. Optionally, the diameter of the aperture may be based on the type of the sample.

In some embodiments, the condenser lens and the sample may each be centered on the optical axis of the imaging device such that the light from the center of the condenser lens illuminates the sample with no angle (e.g., directly, or straight on) and light from the edge of the condenser lens illuminates the sample at an oblique angle. In other words, the optical path of the light from the center of the condenser lens may be coaxial with the optical axis of the imaging device and so may also be parallel to and coaxial with the normal (to the plane) of the sample. The light from the center of the condenser lens may therefore illuminate the sample directly (at no angle (substantially 0°) to the optical axis or to the normal of the sample). This direct illumination of the sample may also be referred to as on-axis illumination or normal illumination. The optical path of the light from the edge of the condenser lens may not be coaxial with the optical axis of the imaging device and may be at a non-zero angle to the optical axis. Consequently, the light from the edge of the condenser lens illuminates the sample at an oblique angle. Oblique angle means a non-zero angle that is not 90°. The oblique angle may be relative to the optical axis, the normal to the sample or the plane of the sample. The oblique angle may be within the range of, for example, 5-85°, 10-80° or 20-70°. The collector lens may be a different size than the condenser lens, and the collector lens may not be coaxial with the optical axis of the imaging device. For example, condenser lens may have a different diameter than the diameter of the collector lens. By way of further example, the condenser lens may have a smaller diameter than the diameter of collector lens. Optionally, the light emitter is centered with respect to the collector lens. Optionally, the oblique illumination system comprises a second light emitter configured to provide illumination of the sample by emitting light. The light emitter may be configured to provide illumination of the sample by emitting light having a first color, and the second light emitter may be configured to provide illumination of the sample by emitting light having a second color, wherein the second color and the first color are different colors. Optionally, the oblique illumination system comprises a second collector lens for collecting the light from the second light emitter, wherein the second collector lens is disposed between the second light emitter and the flowcell; the second light emitter may be centered with respect to the second collector lens; the second collection lens may be a different size than the condenser lens and the second collector lens may not be coaxial with the optical axis of the imaging device; and the light emitter may not be centered with respect to the second collector lens.

Another general aspect includes a method of microscopy. The method may include obliquely illuminating a sample in a flowcell using a light emitter. The method may also include capturing an image of the sample using an image capture device when the sample is obliquely illuminated. Other embodiments of this aspect include corresponding computer systems, apparatus, and computer programs recorded on one or more computer storage devices, each configured to perform the actions of the methods. Features described in respect of the system(s) herein equally apply to the method of microscopy.

Implementations may include one or more of the following features. In some embodiments, the light emitter is a light emitting diode, and the illumination from the light emitter is light pulses. The use of light pulses to illuminate the moving sample advantageously prevent blurring in the captured images (e.g., where the captured images are of a moving sample). In some embodiments, obliquely illuminating the sample includes capturing light from the light emitter by a collector lens, blocking the light from the collector lens at all locations of an aperture mask except through an aperture that is not coaxial with an optical axis of the image capture device, and directing the light from the aperture toward the sample by a condenser lens to provide the oblique illumination. Optionally, the light emitter, the condenser lens and the collector lens are each centered on the optical axis of the image capture device. In some embodiments, obliquely illuminating the sample includes positioning the light emitter to be not coaxial with an optical axis of the image capture device, collecting light from the light emitter by a collector lens positioned on-center with an axis of the light emitter, and directing the light, by a condenser lens centered on the optical axis of the image capture device, from the collector lens toward the sample to provide the oblique illumination. Optionally, the collector lens is a different size than the condenser lens. Implementations of the described techniques may include hardware, a method or process, or computer software on a computer-accessible medium.

### BRIEF DESCRIPTION OF THE DRAWINGS

FIG. 1 illustrates aspects of a microscopy analyzer system according to some embodiments.

FIG. 2 illustrates an oblique illumination system according to some embodiments.

FIG. 3 illustrates another oblique illumination system according to some embodiments.

FIG. 4 illustrates a method for oblique illumination according to some embodiments.

FIG. 5 illustrates another method for oblique illumination according to some embodiments.

FIG. 6 illustrates example images from an oblique illumination system, according to some embodiments.

FIG. 7 illustrates a block diagram of an example computer system according to some embodiments.

### DETAILED DESCRIPTION

Analysis of a cell or particle from a living organism (e.g., humans, animals, and plants) can be used as a medical diagnostic tool used to identify diseases and cell defects as well as healthy cells. Capturing the cells or particles for analysis can be done by collection of particles through, for example, fluids from the living organism (i.e., a biological sample). For example, a blood sample or a urine sample from a person each contain cells that can be analyzed for type and quantity of cells, which can be provided to healthcare professionals for analysis. Additionally, other particles within the sample may be identified and provided for review.

Routine urinalysis is the third most frequently ordered patient laboratory test profile by physicians worldwide. Urinalysis is commonly requested when screening new patients for occult metabolic or renal-urinary tract disease, when evaluating the status of patients with chronic renal or urinary disease, or when assessing pre- or post-surgical status.

A routine laboratory urine examination may include a panel of semi quantitative chemistry assays via impregnated-paper test strip to detect the presence of hemoglobin, glucose, bilirubin, and other substances, a “macroscopic” examination to visually judge the color (related to diseases or drug metabolites present) and clarity (based on particulate content), and a microscopic examination of formed particulate elements in urine, after concentrating the urine to maximize sensitivity, the presence of which directly reflects the state of the kidneys, urinary tract, and bladder.

Particulate types often present in normal urine include red and white blood cells (produced by vascular leakage), epithelial cells of various types which line the renal and urinary tract, crystals of dissolved metabolites or drugs which may form under certain acid/base conditions, organisms such as bacteria, yeast, or trichomonas, and “casts” formed of a precipitated protein released from the renal glomerula during stress. Diseases of the kidneys may cause renal bleeding leading to increased blood cell concentrations observed, leakage of the glomerular membranes causing enhanced formation of casts, and increased exfoliation of the renal lining epithelial cells.

Diseases of the lower urinary tract may be characterized by blood cells due to inflammatory bleeding, exfoliation of transitional epithelium, and findings of infectious organisms. Since some urinary analytes are present both in health and disease, while others are exclusively associated with pathologic states, both the detection and quantitation of urine particulates against reference ranges are essential.

In general, the presence of formed urine sediment elements provides different diagnostic information from that of the urine chemistry profile and macroscopic exam since only the chemistries which measure hemoglobin and leukocyte esterase directly relate to sediment findings (red and white blood cells).

Blood cell analysis is one of the most commonly performed medical tests for providing an overview of a patient's health status. A blood sample can be drawn from a patient's body and stored in a test tube containing an anticoagulant to prevent clotting. A whole blood sample normally comprises three major classes of blood cells including red blood cells (i.e., erythrocytes), white blood cells (i.e., leukocytes) and platelets (i.e., thrombocytes). Each class can be further divided into subclasses of members. For example, five major types or subclasses of white blood cells have different shapes and functions. White blood cells may include neutrophils, lymphocytes, monocytes, cosinophils, and basophils. There are also subclasses of the red blood cell types. The appearances of particles in a sample may differ according to pathological conditions, cell maturity and other causes. Red blood cell subclasses may include reticulocytes and nucleated red blood cells.

Urine cell and particle analysis is also commonly performed to provide information about a patient's health. The patient may provide a urine sample without any invasive techniques. Because the procedure is not invasive, it can be done repeatedly without impact to the person providing the sample. The urine may include many cells and particles, many of which may be translucent and difficult to differentiate from the rest of the fluid sample. Techniques described herein make differentiation and identification of these translucent particles more accurate and effective.

Unless expressly indicated otherwise, references to “particle” or “particles” made in this disclosure will be understood to encompass any discrete or formed object dispersed in a fluid. As used herein, “particle” can include all measurable and detectable (e.g., by image and/or other measurable parameters) components in biological fluids. The particles are of any material, any shape, and any size. Particles can comprise cells. Examples of particles include but are not limited to cells, including blood cells, fetal cells, epithelials, stem cells, tumor cells, or bacteria, parasites, or fragments of any of the foregoing or other fragments in a biological fluid. Blood cells may be any blood cell, including any normal or abnormal, mature or immature cells which potentially exist in a biological fluid, for example, red blood cells (“RBCs”), white blood cells (“WBCs”), platelets (“PLTs”) and other cells. The members also include immature or abnormal cells. Immature WBCs may include metamyelocytes, myelocytes, pro-myelocytes, and blasts. In addition to mature RBCs, members of RBCs may include nucleated RBCs (“NTRCs”) and reticulocytes. PLTs may include “giant” PLTs and PLT clumps. Throughout the specification, the images are described as being an image of a cell or a particle. Though referred to as a cell in many cases, the images can be of any particle. Platelets, reticulocytes, nucleated RBCs, and WBCs, including neutrophils, lymphocytes, monocytes, cosinophils, basophils, and immature WBCs including blasts, promyelocytes, myelocytes, or metamyelocytes are counted and analyzed as particles.

Exemplary urine particles can include urine sediment particles. Exemplary urine sediment particles can include erythrocytes (i.e., RBCs), dysmorphic erythrocytes, leukocytes (i.e., WBCs), neutrophils, lymphocytes, phagocytic cells, cosinophils, basophils, squamous epithelial cells, transitional epithelial cells, decoy cells, renal tubular epithelial cells, casts, crystals, bacteria, yeast, parasites, oval fat bodies, fat droplets, spermatozoa, mucus, trichomonas, cell clumps, and cell fragments. Exemplary cells can include red blood cells, white blood cells, and epithelials. Exemplary casts can include acellular casts, hyaline casts, unclassified cast, granular casts, waxy casts, broad casts, fatty casts, crystal casts, RBC casts, WBC casts, cellular casts. Exemplary crystals can include, for example, calcium oxalate, triple phosphate, calcium phosphate, uric acid, calcium carbonate, leucine, cystine, tyrosine, and amorphous crystals. Exemplary non-squamous epithelial cells can include, for example, renal tubular epithelials and transitional epithelials. Exemplary yeast can include, for example, budding yeast and yeast with pseudohyphae. Exemplary urinary sediment particle can also include RBC clumps, fat, oval fat bodies, and trichomonas. Certain of these particles may be difficult to see in imaging due to, for example, their translucent appearance. For example, hyaline casts are translucent and may be difficult to see in images. Using the oblique illumination described herein, particles that are otherwise difficult to see in images, such as hyaline casts, become more visible in the images captured using oblique illumination.

Blood cell analysis, for example, or analysis of urine or other body fluids, can be done using counting techniques. In counting techniques based on imaging, pixel data images of a prepared sample that may be passing through a viewing area are captured using a microscopy objective lens coupled to a digital camera. The pixel image data can be analyzed using data processing techniques and also displayed on a monitor. The pixel data images may further be stored on a storage device within the system or transmitted to an external location.

The term high optical resolution imaging device can include devices that are capable of obtaining particles images with sufficient visual distinctions to differentiate morphological features and/or changes. Exemplary high optical resolution imaging devices can include devices with an optical resolution of 1 μm or lower, including for example, 0.2 to 0.5 μm, such as for example, 0.345 μm.

In some embodiments, the images obtained in any of the compositions and/or methods of this invention may be digitized images. Optionally, at least part of the procedure for obtaining the images is automated. In some embodiments, the images may be obtained using a visual analyzer comprising a flowcell, a high optical resolution imaging device or a digital image capture device.

Optionally, the images provide information relating to the cytosolic, cell nucleus, and/or nuclear components of the cell. Optionally, the images provide information relating to the granular component and/or other morphological features of the cell. Optionally, the images provide information relating to cytosolic, nuclear and/or granular components of the cell. The granular and/or nuclear images and/or features are determinative for cell categorization and subcategorization both independently or in combination with each other.

In the following description, for the purposes of explanation, specific details are set forth in order to provide a thorough understanding of embodiments of the invention. However, it will be apparent that various embodiments may be practiced without these specific details. The figures and description are not intended to be restrictive.

Systems depicted in some of the figures may be provided in various configurations. Optionally, the systems may be configured as a distributed system where one or more components of the system are distributed across one or more networks in a cloud computing system. All features of the described systems are applicable to the described methods mutatis mutandis, and vice versa.

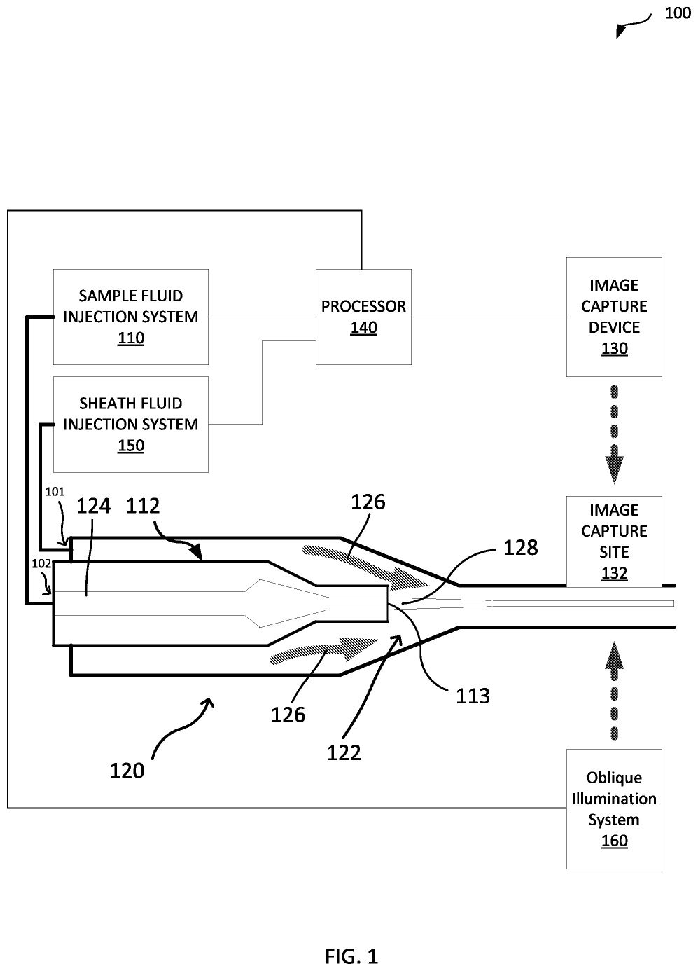

FIG. 1 depicts aspects of a system 100 for imaging particles in a fluid sample. The fluid sample can be a bodily fluid sample such as a blood fluid sample or a urine sample. As shown here, system 100 includes a sample fluid injection system 110, a sheath fluid injection system 150, a processor 140, a flowcell 120, an image capture device 130, and an oblique illumination system 160. The flowcell 120 provides a flowpath 122 that transmits a flow of the sheath fluid, optionally in combination with the sample fluid. Within the flowcell 120, the sample may be continuously flowing or moving during image capture. In some embodiments, the sample may be still during image capture such that the flow of sheath fluid may pause to provide a specific portion of the sample for imaging in the image capture site 132. According to some embodiments, the sample fluid injection system 110 can include or be coupled with a cannula or tube 112. The sample fluid injection system 110 can be in fluid communication with the flowpath 122 (e.g., via sample fluid entrance 102), and can operate to inject sample fluid 124 through a distal exit port 113 of the cannula 112 and into a flowing sheath fluid 126 within the flowcell 120 so as to provide a sample fluid stream 128.

The processor 140 may include or be in operative association with a storage medium having a computer application that, when executed by the processor, is configured to cause the sample fluid injection system 110 to inject sample fluid 124 into the flowing sheath fluid 126. As shown here, sheath fluid 126 can be introduced into the flowcell 120 by a sheath fluid injection system 150 (e.g., via sheath fluid entrance 101). For example, the processor 140 may include or be in operative association with a storage medium having a computer application that, when executed by the processor, is configured to cause the sheath fluid injection system 150 to inject sheath fluid 126 into the flowcell 120.

The sample fluid stream 128 has a first thickness T1 adjacent the injection tube 112. The flowpath 122 of the flowcell 120 having a decrease in flowpath size such that the thickness of the sample fluid stream 128 decreases from the initial thickness T1 to a second thickness T2 adjacent an image capture site 132. The image capture device 130 is aligned with the image capture site 132 so as to image a plurality of the particles from the sample fluid at the image capture site 132 of the flowcell 120.

The processor 140 is coupled with the sample fluid injector system 110, the image capture device 130, and optionally the sheath fluid injection system 150. The processor 140 is configured to initiate capture of the images of the plurality of the particles from the sample fluid at the image capture site 132 of the flowcell 120. For example, the processor 140 may include or be in operative association with a storage medium having a computer application that, when executed by the processor, is configured to cause the image capture device 130 to initiate capture of an image of a second plurality of the particles from the second sample fluid at the image capture site 132 of the flowcell 120 after the sample fluid flows past the image capture site 132 and within a period of time of the imaging of the first plurality the particles.

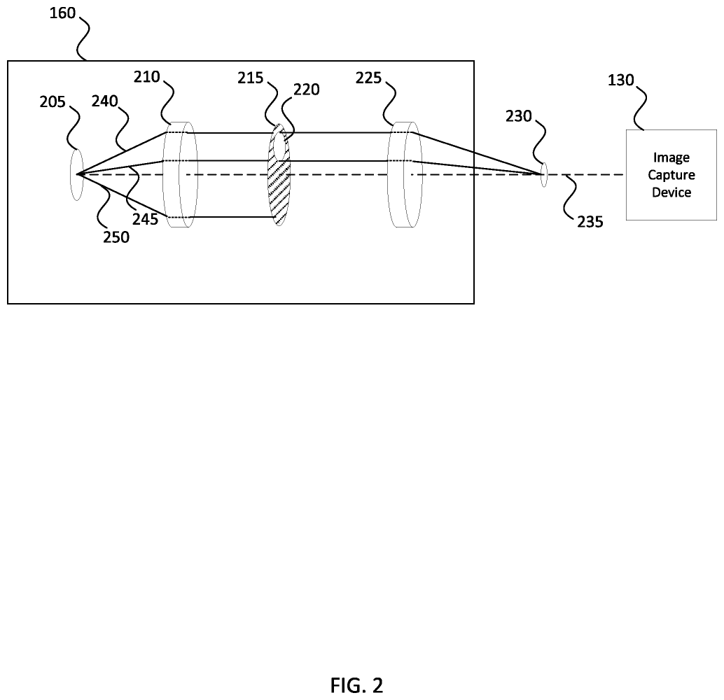

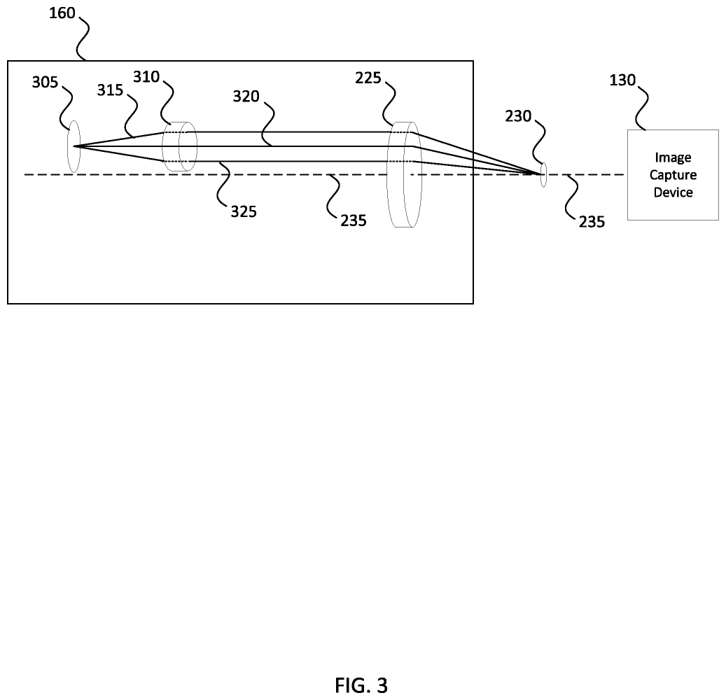

The processor 140 can further control the oblique illumination system 160. The oblique illumination system 160 may provide illumination to the image capture site 132 for capturing images of the cells and particles within the sample fluid by the image capture device 130. The oblique illumination system 160 may provide illumination that is directed toward the sample fluid stream 128 at an oblique angle. At the image capture site 132, the flowcell 120 is transparent, allowing the illumination from oblique illumination system 160 to illuminate the sample fluid for the image capture device 130 to capture the image. The oblique illumination system 160 is described in more detail with respect to FIGS. 2 and 3. The oblique illumination system 160 may provide pulses of illumination (i.e., light) that cause the sample with the sample fluid stream 128 to appear to freeze, allowing image capture device 130 to capture a still image without the blurring effect normally caused by movement of the sample. Processor 140 may coordinate the pulsing of the light emitter within oblique illumination system 160 and the image capture device 130 to cause the image capture device 130 to capture an image while oblique illumination system 160 is illuminating the sample fluid stream 128. In some embodiments, the sample fluid stream 128 may not be moving during image capture and, in such embodiments, the oblique illumination system 160 may provide continuous illumination of the sample. For example, sample fluid stream 128 may move to put a portion of the sample at the image capture site 132 and pause until the image capture device 130 takes an image. In this way, the sample fluid stream 128 may move the portion of the sample into view at the image capture site 132 between image captures. Processor 140 may coordinate the movement of the sample fluid stream 128 and the image capture device 130 to ensure the image capture device 130 captures the image when sample fluid stream 128 is not moving. In such embodiments, oblique illumination system 160 may provide continuous illumination since pulses are not needed to “freeze” the movement of the sample. In some embodiments, even when sample fluid stream 128 is not moving during image capture, oblique illumination system 160 may provide illumination only during the image capture such that pulses of light are provided by oblique illumination system 160 to illuminate the sample only during image capture.

FIG. 2 illustrates a block diagram of oblique illumination system 160 illuminating a sample 230. Oblique illumination system 160 is described with respect to FIG. 1, and an embodiment of how the oblique illumination can be achieved is described here. Sample 230 may be a portion of sample fluid stream 128 which is within the image capture site 132 as described with respect to FIG. 1.

Oblique illumination system 160 may include a light emitter 205, a collector lens 210, an aperture mask 215, and a condenser lens 225. While not shown for the purposes of clarity of the shown and described components, oblique illumination system may include other components including, for example, an interface to processor 140, a housing unit, a coupling component to couple the oblique illumination system 160 to a microscopy system housing, a stabilization coupler to ensure the oblique illumination system 160 does not move with respect to flowcell 120, an alignment mechanism that allows for adjustments to the precise location and alignment of the oblique illumination system with respect to the image capture device, and the like.

Light emitter 205 may be any suitable light source. Light emitter 205 may be a pulsing light emitter 205 to “freeze” the sample for the image capture device 130. When the light from the light emitter 205 flashes on the image capture site 132, image capture device 130 may image the sample 230 and obtain a clear image without blurring from movement. In some embodiments, light emitter 205 may provide continuous illumination of sample 230 when, for example, sample 230 is not moving. Light emitter 205 may be an arc lamp, a light emitting diode (LED), or any other suitable light emitter that is configured to pulse or flash for a very short duration (e.g., one to ten (1-10) microseconds) with a short off duration (e.g., ten to twenty (10-20) milliseconds) as well or to provide continuous illumination. Light emitter 205 may receive a signal from processor 140 indicating when to flash on and off, which can be synchronized with image capture device 130 for capturing images during the light flashes. Imaging at a higher frame rate may be possible as faster processors and imaging devices are developed, and it is not intended to limit the functionality of this system by the example time frames used. In some embodiments, light emitter 205 may be a continuous light source to provide continuous illumination to the image capture site 132. For example, sample 230 may be a still (i.e., not moving during image capture) sample and therefore light pulses are not needed to “freeze” the sample for image capture.

Light emitter 205 may emit light outwardly not only directly along the optical axis 235 but at angles including light beams 240, 245, and 250 and everywhere in between. Light emitter 205 may be centered upon the optical axis 235. The optical axis 235 may be determined based on the image capture device 130. The image capture device 130 has an optical axis 235 around which there is rotational symmetry of the image capture device 130.

Collector lens 210 can be any suitable collector lens for collecting the light emitted from light emitter 205. Collector lens 210 may have a diameter that is determined based on the geometry of light emitter 205. The geometry of the light emitter 205 may emit light, for example, in a point (e.g., an LED emits light that is point-like) or in a line (e.g., an arc lamp emits light that is line-like). The collector lens size is determined based on the geometry of the light such that the light is captured to then disburse a uniform transmission of light. For example, if light emitter 205 is an LED, the collector lens 210 may be a smaller diameter than, for example, if light emitter 205 is an arc lamp. Collector lens 210 may collect the light emitted from light emitter 205 and uniformly transmit the light on to the aperture mask 215. Light beams 240, 245, and 250 indicate such uniform transmission. Collector lens 210 may be centered upon optical axis 235. In some embodiments, collector lens 210 and/or other components including aperture mask 215, condenser lens 225, light emitter 205, and sample 230 may be tilted and still centered on the optical axis 235. Whether one or more components are tilted or not, the illumination provided by oblique illumination system 160 is still oblique illumination of sample 230.

Aperture mask 215 may include aperture 220. Aperture 220 may be a void or hole in the aperture mask 215. Aperture mask 215 may be an opaque mask that blocks light from the collector lens everywhere but through aperture 220. Aperture mask 215 may be the same diameter or larger than the collector lens 210 and centered upon optical axis 235, such that light transmitted uniformly from collector lens 210 is either blocked by aperture mask 215 or allowed through by aperture 220. For example, light beams 240 and 245 are allowed through aperture 220. However, light beam 250 is blocked by aperture mask 215. Aperture 220 may be a circular aperture, the size of which is based on the type of the sample 230. For example, sample 230 that includes particles that are difficult to see (e.g., translucent particles) may be more visible if the aperture 220 is smaller than is needed if particles are less difficult to see (e.g., opaque particles). The geometry of the aperture 220 may be any suitable shape including, for example, circular, elliptical, teardrop, heart, square, triangle, octagon, and so forth. The selection of the shape of the aperture 220 may be based on the type of sample 230. For oblique illumination, aperture 220 is not coaxial with the optical axis 235. In other words, the aperture 220 is not centered on optical axis 235. As such, light transmitted through aperture 220 reaches the condenser lens off-center from the optical axis 235. In FIG. 2 this is shown by example light beams 240 and 245, which are not coaxial with optical axis 235. Of note with respect to aperture mask 215, in previous systems, light loss from the light emitter was approximately ninety-nine percent (99%). The high amount of light loss was due to at least two reasons. First, previous systems used an arc lamp and the shape of the arc of light is a line, but a point of light is much more suitable than a line for manipulating light because with a point it is easier to achieve uniform illumination. To make the line appear more uniform there is a diffuser inside the illuminator that blurs the line, but also causes light to disburse in all different directors so a lot of light is lost. Using an LED in the present solution achieves higher light efficiency. Second, the small numerical aperture used in the present solution system is larger than the small numerical aperture of previous systems. The aperture in prior systems needs to be very small for low numerical aperture images to make the details visible. The larger numerical aperture used in the present solution therefore provides higher light efficiency. With the described oblique illumination system 160, approximately twenty-five percent (25%) of the light is retained, which is a large efficiency increase (i.e., only 75% loss against the previous 99% loss). This efficiency gain allows for a lower powered light emitter 205 to be used, lowering the cost of oblique illumination system 160 and the overall microscopy system. In addition, a smaller light emitter 205 provides a more point-like illumination, so even less light is lost because it is easier to make the uniform illumination pattern with the point-like illumination from the light emitter 205. The lower cost is attributed to the lower cost of lower power electronics, the lower cost to power the lower power electronics, and the lower cost because replacement of the light emitter 205 may be needed less frequently.

Condenser lens 225 is configured to angle the light received toward the sample 230. All light that passed through aperture 220 reaches condenser lens 225 and is transmitted toward sample 230. Condenser lens 225 may be the same diameter as the collector lens 210. In some embodiments, condenser lens 225 and collector lens 210 are not the same size. For example, condenser lens 225 may be smaller diameter than the diameter of collector lens 210. Condenser lens 225 is centered on the optical axis 235. The light from aperture 220 is received at condenser lens 225 and directed toward sample 230, so that sample 230 is illuminated with light at an oblique angle. As shown in FIG. 2, light beams 240 and 245 are directed toward sample 230 so that sample 230 is illuminated. With respect to FIG. 1, image capture site 132 is illuminated. The resulting illumination of sample 230 is oblique illumination because the light beams from aperture 220 arrive upon sample 230 at an oblique angle. Light directly along the optical axis 235 is blocked by aperture mask 215 and therefore, all illumination of sample 230 is oblique illumination.

FIG. 3 illustrates a block diagram of an alternative embodiment of oblique illumination system 160 illuminating the sample 230. Oblique illumination system 160 is described with respect to FIG. 1, and an alternative embodiment over that described in FIG. 2 of how the oblique illumination can be achieved is described here. Sample 230 may be a portion of sample fluid stream 128 which is within the image capture site 132 as described with respect to FIG. 1.

In this embodiment, oblique illumination system 160 may include a light emitter 305, a collector lens 310, and a condenser lens 225. While not shown for the purposes of clarity of the shown and described components, oblique illumination system may include other components including, for example, an interface to processor 140, a housing unit, a coupling component to couple the oblique illumination system 160 to a microscopy system housing, a stabilization coupler to ensure the oblique illumination system 160 does not move with respect to flowcell 120, an alignment mechanism that allows for adjustments to the precise location and alignment of the oblique illumination system with respect to the image capture device, and the like.

Light emitter 305 may be any suitable light source. Light emitter 305 may be a pulsing light emitter 305 to “freeze” the sample for the image capture device 130. Light emitter 305 may be the same as light emitter 205, only located in a different place with respect to optical axis 235. Light emitter 305 may be, however, different than light emitter 205. For example, light emitter 305 may be smaller than light emitter 205. When the light from the light emitter 305 flashes on the image capture site 132, image capture device 130 may image the sample 230 and obtain a clear image without blurring from movement. In some embodiments, light emitter 305 may provide continuous illumination of sample 230 when, for example, sample 230 is not moving. Light emitter 305 may be an arc lamp, a light emitting diode (LED), or any other suitable light emitter that is configured to pulse or flash for a very short duration (e.g., one to ten (1-10) microseconds) with a short off duration (e.g., ten to twenty (10-20) milliseconds) as well or to provide continuous illumination. Light emitter 305 may receive a signal from processor 140 indicating when to flash on and off, which can be synchronized with image capture device 130 for capturing images during the light flashes or pulses. Light emitter 305 may receive a signal from processor 140 indicating when to turn on and off if continuous illumination is used as well. Imaging at a higher frame rate may be possible as faster processors and imaging devices are developed, and it is not intended to limit the functionality of this system by the example time frames used. In some embodiments, light emitter 305 may be a continuous light source to provide continuous illumination to the image capture site 132. For example, sample 230 may be a still (i.e., not moving during image capture) sample and therefore light pulses are not needed to “freeze” the sample for image capture.

Light emitter 305 may emit light parallel to the optical axis 235 (shown by light beam 320) as well as at angles including light beams 315 and 325 and everywhere in between. Light emitter 305 may be not coaxial with the optical axis 235. The optical axis 235 may be determined based on the image capture device 130. The image capture device 130 has an optical axis 235 around which there is rotational symmetry of the image capture device 130. The light emitter 205 may be centered upon the optical axis 235.

Collector lens 310 can be any suitable collector lens for collecting the light emitted from light emitter 305. Collector lens 310 may have a diameter that is determined based on the geometry of light emitter 305. The geometry of the light emitter 305 may emit light, for example, in a point (e.g., an LED emits light that is point-like) or in a line (e.g., an arc lamp emits light that is line-like). The collector lens size is determined based on the geometry of the light such that the light is captured to then disburse a uniform transmission of light. For example, if light emitter 305 is an LED, the collector lens 310 may be a smaller diameter than, for example, if light emitter 305 is an arc lamp. In some embodiments, collector lens 310 may be sized based on the type of sample 230. Collector lens 310 may collect the light emitted from light emitter 305 and uniformly transmit the light to condenser lens 225. Light beams 315, 320, and 325 indicate such uniform transmission. Collector lens 310 may be not coaxial with optical axis 235 but centered with respect to light emitter 305. This non-coaxial positioning results in the desired oblique illumination. In some embodiments, collector lens 310 and/or other components including condenser lens 225, light emitter 305, and sample 230 may be tilted. Whether one or more components are tilted or not, the illumination provided by oblique illumination system 160 is still oblique illumination of sample 230.

Note that the light from light emitter 305 is all collected by collector lens 310 and transmitted to condenser lens 225. This embodiment is even more efficient than the embodiment described with respect to FIG. 2. There is very little light loss because all of the light from light emitter 305 is directed toward sample 230. In this way, an even lower power light emitter 305 may improve cost efficiency.

Condenser lens 225 is described above with respect to FIG. 2. As described with respect to FIG. 2, condenser lens 225 is configured to direct the light received from the collector lens 310 toward the sample 230. All light from light emitter 305 and collected by collector lens 310 reaches condenser lens 225 and is directed toward sample 230. Condenser lens 225 may be a larger diameter than collector lens 310 as discussed above. Condenser lens 225 is centered on the optical axis 235. The light from collector lens 310, which is not coaxial with the optical axis 235, is directed toward sample 230, so that sample 230 is illuminated with light at an oblique angle. As shown in FIG. 3, light beams 315, 320, and 325 are directed toward sample 230 so that sample 230 is illuminated. With respect to FIG. 1, image capture site 132 is illuminated. The resulting illumination of sample 230 is oblique illumination because the light beams arrive upon sample 230 at an oblique angle. No light is directly transmitted down the optical axis 235 and therefore, all illumination of sample 230 is oblique illumination.

In some embodiments, the area depicted in FIG. 3 below light emitter 305 may be used to, for example, provide a second oblique illumination light emitter and collector lens (not shown). In some embodiments, differing colors of light may be emitted from light emitter 305 and the second light emitter.

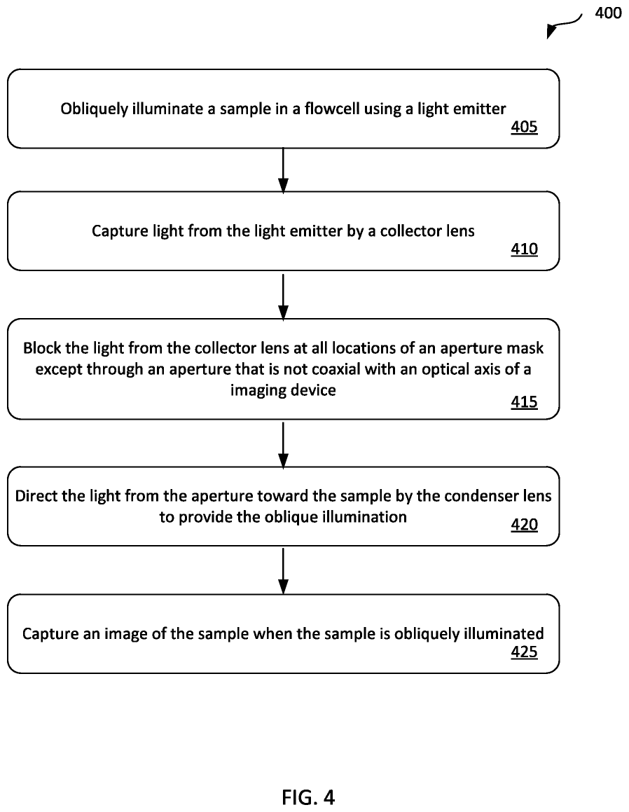

FIG. 4 illustrates a method 400 for oblique illumination and image capture of a sample. Method 400 may be performed using, for example, system 100 of FIG. 1. More specifically, method 400 may be performed by oblique illumination system 160 as described with respect to FIG. 2 and image capture device 130. Method 400 may begin at step 405 with obliquely illuminating a sample in a flowcell using a light emitter. Oblique illumination system 160 may obliquely illuminate the sample 230 in the flowcell 120 using light emitter 205, for example.

At step 410, a substep of step 405, a collector lens may capture light from the light emitter. For example, collector lens 210 may capture light emitted from light emitter 205. Light emitter 205 may pulse because, for example, processor 140 contains processor readable instructions that cause the light emitter 205 to pulse or flash, which can allow for image capture of a moving object without blurring. Therefore, the sample may be flowing through a flowcell and an image may be captured that is not blurry due to the pulsing light. In some embodiments light emitter 205 may be a continuous illumination source and the sample may be still during image capture.

At step 415, a further substep of step 405, an aperture mask may block the light from the collector lens at all locations except through an aperture that is not coaxial with an optical axis of the imaging device. For example, aperture mask 215 may block the light from collector lens 210 at all location except through aperture 220. Aperture 220 is not coaxial with the optical axis 235 of image capture device 130.

At step 420, a further substep of 405, the condenser lens may direct the light from the aperture toward the sample to provide the oblique illumination. For example, condenser lens 225 may direct the light (light beams 240 and 245) from the aperture 220 toward the sample 230 to provide the oblique illumination.

At step 425, an image capture device may capture an image of the sample when the sample is obliquely illuminated. For example, image capture device 130 may capture an image of the sample 230 within flowcell 120 at the image capture site 132 when the sample is obliquely illuminated by oblique illumination system 160.

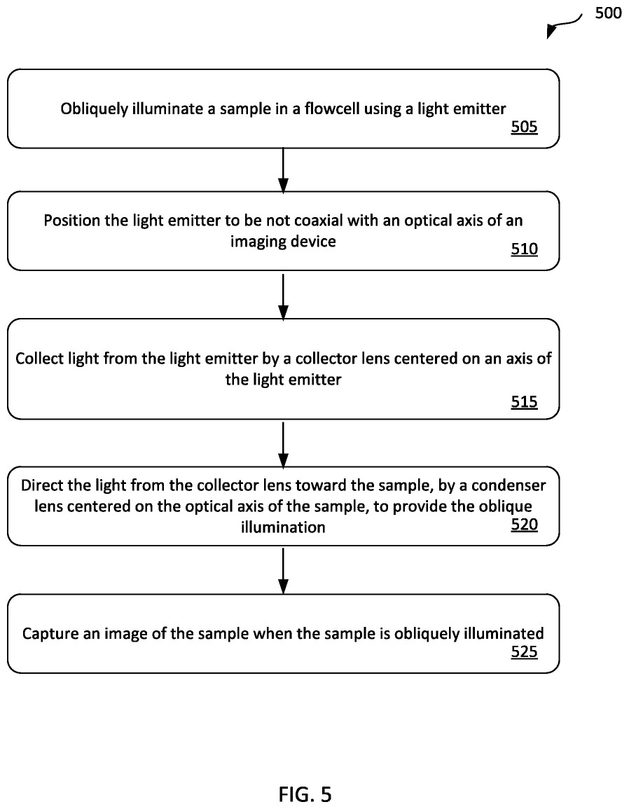

FIG. 5 illustrates another method 500 for oblique illumination and image capture of a sample. Method 500 may be performed using, for example, system 100 of FIG. 1. More specifically, method 500 may be performed by oblique illumination system 160 as described with respect to FIG. 3 and image capture device 130. Method 500 may begin at step 505 with obliquely illuminating a sample in a flowcell using a light emitter. Oblique illumination system 160 may obliquely illuminate the sample 230 in the flowcell 120 using light emitter 305, for example.

At step 510, a substep of step 505, a light emitter is positioned to be not coaxial with an optical axis of an imaging device. For example, light emitter 305 may be positioned to be not coaxial with the optical axis 235 of image capture device 130. Light emitter 305 may pulse because, for example, processor 140 contains processor readable instructions that cause the light emitter 305 to pulse or flash, which can be coordinated with the image capture device 130 to capture non-blurry images of the sample within flowcell 120 when the sample is moving. In some embodiments the light emitter 305 may emit a continuous illumination used to capture images of the sample when it is still.

At step 515, a further substep of step 505, a collector lens may collect light from the light emitter. The collector lens may be centered on an axis of the light emitter. For example, collector lens 310 may collect the light from light emitter 305. Collector lens 310 may be centered with respect to light emitter 305. For example, an axis extending from the center straight out from light emitter 305, which is exemplified by light beam 320 in FIG. 3, may be the axis upon which collector lens 310 is centered.

At step 520, a further substep of 505, the condenser lens may direct the light from the collector lens toward the sample to provide the oblique illumination. For example, condenser lens 225 may direct the light (light beams 315, 320, and 325) from the collector lens 310 toward the sample 230 to provide the oblique illumination.

At step 525, an image capture device may capture an image of the sample when the sample is obliquely illuminated. For example, image capture device 130 may capture an image of the sample 230 within flowcell 120 at the image capture site 132 when the sample is obliquely illuminated by oblique illumination system 160.

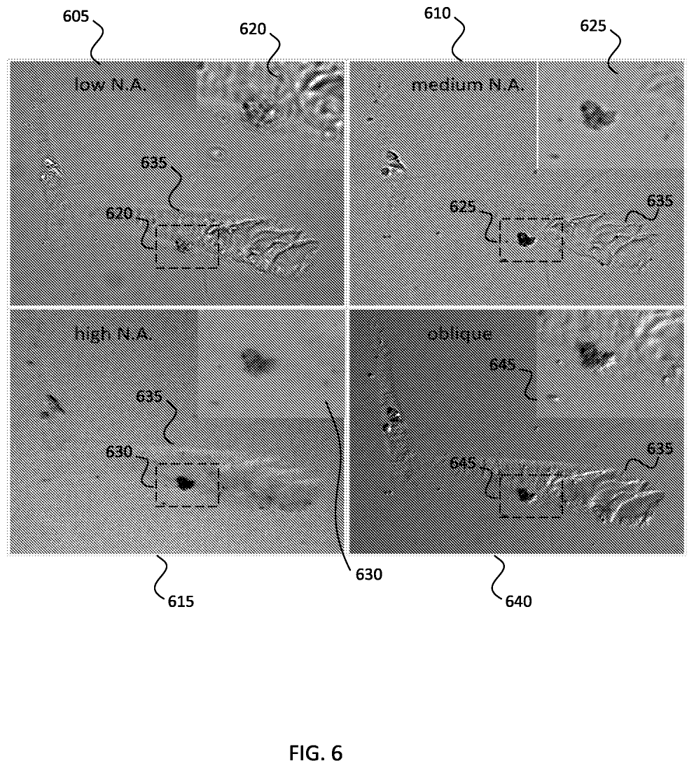

FIG. 6 provides alternative example images of a sample. In microscopy systems, bright field lighting can be used to provide the illumination of the sample. In these systems, the lighting source is behind the sample with respect to the position of the image capture device. This is shown with respect to FIG. 1 in that oblique illumination system 160 is opposite the image capture device 130 with respect to image capture site 132 of flowcell 120.

The size of the aperture has an impact on the resolution of the resulting images. For example, a smaller aperture (e.g., aperture 220) of the illumination system may more closely focus the illumination of the sample resulting in differing resolution of imaging. In systems that do not use oblique illumination, the aperture is centered on the optical axis of the imaging device. A low numerical aperture (meaning the aperture is smaller or has a smaller diameter) may result in a lower resolution image for seeing a particle within a sample than a high numerical aperture (meaning the aperture is larger, and may be as large as the condenser lens). FIG. 6 illustrates three images 605, 610, and 615 taken while the particle 635 was illuminated with an illumination system having varying numerical apertures to show the change in available information in each image. As seen, image 605, taken with an illumination system using a low numerical aperture of approximately 0.1 shows some definition of the particle 635. Inset 620, shown within the dotted box, shows closer detail of a portion of particle 635. The resolution and detail shown in image 605 that is shown in inset 620 and the particle within inset 620 is fairly unclear.

Image 610, taken with an illumination system using a medium numerical aperture of approximately 0.2 shows some definition of the particle 635, and particle 635 is more clear than that shown in image 605. Inset 625, shown within the dotted box, shows closer detail of the portion of particle 635 similar to inset 620. Inset 625 shows that the clarity of the portion of the particle is clearer than in inset 620.

Image 615, taken with an illumination system using a high numerical aperture of approximately 0.4 shows the greatest amount of definition of the particle 635 out of images 605, 610, and 615. Inset 630, shown within the dotted box, shows closer detail of a portion of particle 635 similar to insets 620 and 625. The details of particle 635 are much more defined in image 615.

Image 640 is an image captured while the particle 635 is illuminated with oblique illumination using a system such as oblique illumination system 160. Image 640 has an embossed, three-dimensional appearance. The image is not truly three dimensional, but the oblique illumination results in such an appearance. The details of particles, particularly translucent particles, such as particle 635 are much clearer in image 635 using oblique illumination than of those shown in images 605, 610, and 615. The embossed, three-dimensional like appearance provides depth to even translucent particles, making them more visible to a human analyst and/or a software analysis system.

As previously noted, existing microscopy systems typically use bright field illumination or other, symmetrical illumination techniques. There are a couple of reasons for this. The first reason is that in engineering, the goal is often to find symmetry. It is easier to work with symmetrical solutions because the design and analysis of optical systems is simpler with symmetry. For that reason, symmetrical solutions are usually those that are found and used, and once a working solution is found, it may be that the search ends. It is more rare to look for asymmetry or asymmetrical solutions. For that reason, oblique illumination, which departs from symmetry by providing illumination that is off-center from the optical axis, is not an obvious choice to use for microscopy systems as described above. Another reason is that the change to an embossed, three-dimensional looking image is a large change from the typical two-dimensional images as shown in images 605, 610, and 615. Microscopy systems using symmetrical illumination have existed for many years. The images captured by a microscopy system are often analyzed by either software or humans to identify anomalies or normalcies for determining whether a patient from which the sample was taken has a disease or health issue. Software used to analyze and rate the images are often programmed using two-dimensional images. Similarly, human analysts have been trained using two-dimensional images. The change in imaging to an image that has an embossed, three-dimensional appearance may require reprogramming of analysis software and additional training for human analysts, making the change not an obvious choice.

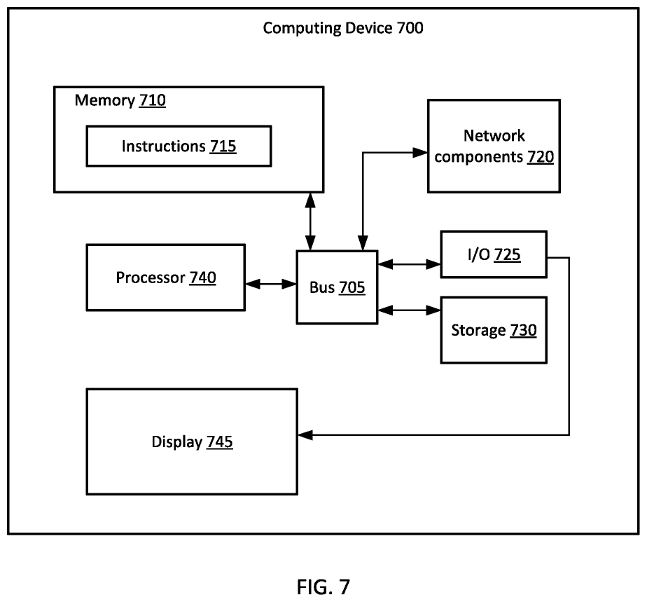

FIG. 7 illustrates a block diagram of an example computing device 700 usable for performing image capture and oblique illumination as described herein. The computing device 700 can be or include, for example, a custom purpose and/or custom designed computing device, a server computer, a laptop computer, desktop computer, tablet, e-reader, smart phone or mobile device, smart watch, personal data assistant (PDA), or other electronic device.

The computing device 700 can include a processor 740 interfaced with other hardware via a bus 705. A memory 710, which can include any suitable tangible (and non-transitory) computer readable medium, such as RAM, ROM, EEPROM, or the like, can embody program components (e.g., instructions 715) that configure operation of the computing device 700. In some examples, the computing device 700 can include input/output (“I/O”) interface components 725 (e.g., for interfacing with a display 745, keyboard, mouse, and/or the like) and additional storage 730.

The computing device 700 can include network components 720. Network components 720 can represent one or more of any components that facilitate a network connection. In some examples, the network components 720 can facilitate a wireless connection and include wireless interfaces such as IEEE 802.11, Bluetooth, or radio interfaces for accessing cellular telephone networks (e.g., a transceiver/antenna for accessing CDMA, GSM, UMTS, or other mobile communications network). In other examples, the network components 720 can be wired and can include interfaces such as Ethernet, USB, IEEE 1394, RS 232, and/or the like.

Although FIG. 7 depicts a single computing device 700 with a single processor 740, the system can include any number of computing devices 700 and any number of processors 740. For example, multiple computing devices 700 or multiple processors 740 can be distributed over a wired or wireless network (e.g., a Wide Area Network, Local Area Network, or the Internet). The multiple computing devices 700 or multiple processors 740 can perform any of the steps of the present disclosure individually or in coordination with one another.

Each of the calculations or operations described herein may be performed using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; on a flash drive; or any other digital or analog storage media), or the like.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention.

It is to be understood that the figures and descriptions of embodiments of the invention have been simplified to illustrate elements that are relevant for a clear understanding of the invention. Those of ordinary skill in the art will recognize, however, that these and other elements may be desirable. However, because such elements are well known in the art, and because they do not facilitate a better understanding of the invention, a discussion of such elements is not provided herein. It should be appreciated that the figures are presented for illustrative purposes and not as construction drawings. Omitted details and modifications or alternative embodiments are within the purview of persons of ordinary skill in the art.

The examples presented herein are intended to illustrate potential and specific implementations of the invention. It can be appreciated that the examples are intended primarily for purposes of illustration of the invention for those skilled in the art. There may be variations to these diagrams or the operations described herein without departing from the spirit of the invention.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described in the claims.

All patents, patent publications, patent applications, journal articles, books, technical references, and the like discussed in the instant disclosure are incorporated herein by reference in their entirety for all purposes.

The technology may also be implemented as described in accordance with the following clauses:

Clause 1. A system for microscopy, the system comprising:
a flowcell containing a sample;
a light emitter configured to provide illumination of the sample by emitting light, wherein the illumination is used to capture images of the sample;
a collector lens for collecting the light from the light emitter, the collector lens disposed between the light emitter and the flowcell;
a condenser lens for receiving and directing the light from the collector lens toward the sample in the flowcell, wherein the condenser lens is disposed between the flowcell and the collector lens;
an aperture mask comprising an aperture, wherein the aperture mask allows at least a portion of the light from the collector lens to pass through the aperture, and wherein the aperture is not centered on the aperture mask such that the illumination of the sample is non-symmetrical; and
an imaging device for capturing the images of the sample during the illumination of the sample.

Clause 2. The system of clause 1, wherein the sample is one of a urine sample, a blood sample, a cerebrospinal fluid sample, a synovial fluid sample, a serous fluid sample, a pleural fluid sample, a pericardial fluid sample, a peritoneal fluid sample, and an amniotic fluid sample.

Clause 3. The system of clause 1 or clause 2, wherein a diameter of the aperture is based on a type of the sample.

Clause 4. The system of any preceding clause, wherein the light emitter is a light emitting diode.

Clause 5. The system of any one of clauses 1 to 3, wherein the light emitter is an arc lamp.

Clause 6. The system of any preceding clause, wherein the light emitter, the collector lens, the aperture mask, the condenser lens, and the sample are each centered on an optical axis of the imaging device.

Clause 7. The system of any preceding clause, wherein the sample in the flowcell is moving and the illumination from the light emitter is light pulses that prevent blurring in the captured images.

Clause 8. The system of any one of clauses 1 to 6, wherein the sample in the flowcell is not moving and the illumination from the light emitter is continuous.

Clause 9. A system for microscopy, the system comprising:
a flowcell containing a sample;
a light emitter configured to provide illumination of the sample by emitting light, wherein the illumination is used to capture images of the sample;
a collector lens for collecting the light from the light emitter, wherein the collector lens is disposed between the flowcell and the light emitter;
a condenser lens for receiving and directing the light from the collector lens toward the sample in the flowcell, wherein the condenser lens is disposed between the flowcell and the collector lens; and
an imaging device for capturing images of the sample during the illumination of the sample;
wherein the sample and the condenser lens are each centered on an optical axis of the imaging device such that the light from a center of the condenser lens illuminates the sample with no angle and light from an edge of the condenser lens illuminates the sample at an oblique angle, and
wherein the collector lens is a different size than the condenser lens and the collector lens is not coaxial with the optical axis of the imaging device.

Clause 10. The system of clause 9, wherein the sample is one of a urine sample, a blood sample, a cerebrospinal fluid sample, a synovial fluid sample, a serous fluid sample, a pleural fluid sample, a pericardial fluid sample, a peritoneal fluid sample, and an amniotic fluid sample.

Clause 11. The system of clause 9 or clause 10, wherein a diameter of the collector lens is based on a type of the sample.

Clause 12. The system of any one of clauses 9 to 11, wherein the light emitter is centered with respect to the collector lens.

Clause 13. The system of any one of clauses 9 to 12, wherein the light emitter is a light emitting diode.

Clause 14. The system of any one of clauses 9 to 13, wherein the light emitter is an arc lamp.

Clause 15. The system of any one of clauses 9 to 14, wherein the sample in the flowcell is moving and the illumination from the light emitter is light pulses that prevent blurring in the captured images.

Clause 16. The system of any one of clauses 9 to 14, wherein the sample in the flowcell is not moving and the illumination from the light emitter is continuous.

Clause 17. A method of microscopy, the method comprising:
obliquely illuminating a sample in a flowcell using a light emitter; and capturing an image of the sample using an image capture device when the sample is obliquely illuminated.

Clause 18. The method of clause 17, wherein the sample in the flowcell is moving, the light emitter is a light emitting diode, and the illumination from the light emitter is light pulses that prevent blurring in the captured images.

Clause 19. The method of clause 17 or clause 18, wherein obliquely illuminating the sample comprises:
receiving light from the light emitter by a collector lens;
blocking light from the collector lens at all locations of an aperture mask except through an aperture that is not coaxial with an optical axis of the image capture device; and
directing the light from the aperture toward the sample by a condenser lens to provide the oblique illumination.

Clause 20. The method of clause 17 or clause 18, wherein obliquely illuminating the sample comprises:
positioning the light emitter to be not coaxial with an optical axis of the image capture device;
collecting light from the light emitter by a collector lens positioned on-center with an axis of the light emitter; and
directing, by a condenser lens centered on the optical axis of the image capture device, light from the collector lens toward the sample to provide the oblique illumination.

1. A system for microscopy, the system comprising:
a flowcell containing a sample;
an oblique illumination system configured to obliquely illuminate the sample in the an imaging device configured to capture the images of the sample during the illumination of the sample;
wherein the oblique illumination system comprises:
a light emitter configured to provide illumination of the sample by emitting light, wherein the illumination is used to capture images of the sample;
a collector lens for collecting the light from the light emitter, wherein the collector lens is disposed between the light emitter and the flowcell; and
a condenser lens for receiving and directing the light from the collector lens toward the sample in the flowcell, wherein the condenser lens is disposed between the flowcell and the collector lens.

2. The system of claim 1, wherein the sample is one of a urine sample, a blood sample, a cerebrospinal fluid sample, a synovial fluid sample, a serous fluid sample, a pleural fluid sample, a pericardial fluid sample, a peritoneal fluid sample, and an amniotic fluid sample.

3. The system of claim 1, wherein the light emitter is a light emitting diode.

4. The system of claim 1, wherein the light emitter is an arc lamp.

5. The system of claim 1, wherein the sample in the flowcell is moving and the illumination from the light emitter is light pulses that prevent blurring in the captured images.

6. The system of claim 1, wherein the sample in the flowcell is not moving and the illumination from the light emitter is continuous.

7. The system of claim 1, wherein the oblique illumination system further comprises an aperture mask comprising an aperture, wherein the aperture mask allows at least a portion of the light from the collector lens to pass through the aperture, and wherein the aperture is not centered on the aperture mask such that the illumination of the sample is non-symmetrical.

8. The system of claim 7, further wherein the light emitter, the collector lens, the aperture mask, the condenser lens, and the sample are each centered on an optical axis of the imaging device.

9. The system of claim 7, wherein a diameter of the aperture is based on a type of the sample.

10. The system of claim 1, wherein the sample and the condenser lens are each centered on the optical axis of the imaging device such that the light from a center of the condenser lens illuminates the sample with no angle and light from an edge of the condenser lens illuminates the sample at an oblique angle, and wherein the collector lens is a different size than the condenser lens and the collector lens is not coaxial with the optical axis of the imaging device.

11. The system of claim 10, wherein the light emitter is centered with respect to the collector lens.

12. The system of claim 10, wherein the oblique illumination system comprises a second light emitter configured to provide illumination of the sample by emitting light.

13. The system of claim 12, wherein the light emitter is configured to provide illumination of the sample by emitting light having a first color, and the second light emitter is configured to provide illumination of the sample by emitting light having a second color, wherein the second color and the first color are different colors.

14. The system of claim 12, wherein:
the oblique illumination system comprises a second collector lens for collecting the light from the second light emitter, wherein the second collector lens is disposed between the second light emitter and the flowcell;
the second light emitter is centered with respect to the second collector lens;
the second collector lens is a different size than the condenser lens and the second collector lens is not coaxial with the optical axis of the imaging device; and
the light emitter is not centered with respect to the second collector lens.

15. A method of microscopy, the method comprising:
obliquely illuminating a sample in a flowcell using a light emitter; and
capturing an image of the sample using an image capture device when the sample is obliquely illuminated.

16. The method of claim 15, wherein the sample in the flowcell is moving, the light emitter is a light emitting diode, and the illumination from the light emitter is light pulses that prevent blurring in the captured images.

17. The method of claim 15, wherein obliquely illuminating the sample comprises:
receiving light from the light emitter by a collector lens;
blocking light from the collector lens at all locations of an aperture mask except through an aperture that is not coaxial with an optical axis of the image capture device; and
directing the light from the aperture toward the sample by a condenser lens to provide the oblique illumination.

18. The method of claim 17, wherein the light emitter, the condenser lens and the collector lens are each centered on the optical axis of the image capture device.

19. The method of claim 15, wherein obliquely illuminating the sample comprises:
positioning the light emitter to be not coaxial with an optical axis of the image capture device;
collecting light from the light emitter by a collector lens positioned on-center with an axis of the light emitter; and
directing, by a condenser lens centered on the optical axis of the image capture device, light from the collector lens toward the sample to provide the oblique illumination.

20. The method of claim 19, wherein the collector lens is a different size than the condenser lens.
